(19) United States
(12) Patent Application Publication
(10) Pub. No.: US 2022/0267599 A1
(43) Pub. Date: Aug. 25, 2022

(54) RESIN COMPOSITION AND RESIN MOLDED ARTICLE MADE OF THE RESIN COMPOSITION

(71) Applicant: Toray Industries, Inc., Tokyo (JP)

(72) Inventors: Yuki Furukawa, Nagoya-shi, Aichi (JP); Yoshiyuki Honda, Nagoya-shi, Aichi (JP); Masaru Akita, Nagoya-shi, Aichi (JP); Sadanori Kumazawa, Nagoya-shi, Aichi (JP)

(21) Appl. No.: 17/625,122

(22) PCT Filed: Jul. 16, 2020
(86) PCT No.: PCT/JP2020/027697

§ 371 Date: Jan. 6, 2022

(30) Foreign Application Priority Data
Jul. 24, 2019 (JP) 2019-136357

(51) Int. Cl. C08L 77/02; C08L 23/06; C08L 23/12; C08L 77/06

(52) U.S. Cl. CPC C08L 77/02; C08L 23/06; C08L 23/12; C08L 77/06

(57) ABSTRACT

A resin composition includes a polyolefin resin (a) and a polyamide resin (b) accounting for 100 wt % in total, the polyolefin resin (a) and the polyamide resin (b) accounting for 70 to 30 wt % and 30 to 70 wt %, respectively, and a surface of a molded resin product produced from the resin composition, analyzed by infrared microspectrometry, giving a spectrum peak intensity ratio of 3.0 to 5.0 as calculated by equation (1), wherein a melt viscosity ratio defined by equation (2) is 0.35 to 0.64 when measured at a shear rate of 1.216 second⁻¹ and at a temperature of Tp+20° C., wherein Tp (° C.) represents the melting point of the polyolefin resin (a) or that of the polyamide resin (b), whichever is higher:

$$\begin{matrix}Peak intensity ratio = \frac{absorbance near 2 , 950 {cm}^{- 1}}{absorbance near 3 , 300 {cm}^{- 1}} & ( 1 ) \\ Melt viscosity ratio = \frac{melt viscosity of polyamide resin ( b )}{melt viscosity of polyolefin resin ( a )} . & ( 2 )\end{matrix}$$

### TECHNICAL FIELD

This disclosure relates to a resin composition containing a polyolefin resin and a polyamide resin and being high in resistance to fuel permeation, weldability to polyolefin resins, and moldability. In addition, this disclosure also relates to molded resin products produced from such a resin composition.

### BACKGROUND

In recent years, in various fields such as fuel tank manufacturing, plastic products with permeation resistance have been in wider use for the purpose of preventing leakage of contents, infiltration of outside air and the like, to ensure safety, storage stability, and environmental pollution prevention. In particular, in the fields of fuel tanks of automobiles and their peripheral parts, the conversion from metallic members to plastic members is being actively investigated with the aim of achieving weight reduction, higher moldability, enhanced design freedom, and higher handleability.

Polyolefin resins such as polyethylene resin and polypropylene resin are the mainstream as materials for plastic products for such applications, but it is commonly impossible for polyolefin resins alone to serve sufficiently in realizing a required resistance to fuel permeation and therefore, they are generally jointed with molded members that can work to develop permeation resistance. The joint faces produced are likely to have significant influence on the properties of the resulting moldings.

To solve these problems, some techniques have been proposed (see, for example, JP 4032656 B2) such as alloying a polyolefin resin with a thermoplastic resin that is not a polyolefin resin to control the phase structure.

However, although useful in achieving high permeability resistance and weldability, the technique described in JP '656 cannot work with sufficiently high moldability in surface stripping of the resulting molded resin products.

Furthermore, in recent years, high moldability is also required to ensure high adhesiveness and weldability to polyolefin resins and high yields in producing molded products, which can be realized by, for example, eliminating appearance defects such as surface stripping of the molded products.

Thus, it could be helpful to provide both high level fuel permeation resistance and high weldability to welding material (polyolefin resin) and a polyamide resin composition having high moldability to produce a molded resin product free of surface stripping.

### SUMMARY

We thus provide:
[1] A resin composition including a polyolefin resin (a) and a polyamide resin (b) accounting for 100 wt % in total, the polyolefin resin (a) and the polyamide resin (b) accounting for 70 to 30 wt % and 30 to 70 wt %, respectively, and the surface of a molded resin product produced from the resin composition, analyzed by infrared microspectrometry, giving a spectrum peak intensity ratio of 3.0 to 5.0 as calculated by equation (1):

$$Peak intensity ratio = \frac{absorbance near 2 , 950 {cm}^{- 1}}{absorbance near 3 , 300 {cm}^{- 1}} . \qquad ( 1 )$$

[2] The resin composition as described in [1], wherein the polyolefin resin (a) comprises a modified polyolefin resin (a-1) and an unmodified polyolefin resin (a-2).
[3] The resin composition as described in [2], wherein the modified polyolefin resin (a-1) has an acid value of 12 mgKOH/g to 35 mgKOH/g.
[4] The resin composition as described in either [1] or [2], wherein the polyolefin resin (a) contains a polyolefin resin component modified with at least one compound selected from unsaturated carboxylic acids and derivatives thereof.
[5] The resin composition as described in any one of [1] to [4], wherein the melt viscosity ratio defined by equation (2) given below is 0.35 to 0.64 when measured at a shear rate of 1,216 second⁻¹ and at a temperature of Tp+20° C., wherein Tp (° C.) represents the melting point of the polyolefin resin (a) or that of the polyamide resin (b), whichever is the higher:

$$Melt viscosity ratio = \frac{melt viscosity of polyamide resin ( b )}{melt viscosity of polyolefin resin ( a )} . \qquad ( 2 )$$

[6] The resin composition as described in any one of [1] to [5], wherein a dumbbell shaped test piece with an overall length of 170 mm, a parallel part length of 80 mm, a parallel part width of 10 mm, and a thickness of 4 mm prepared therefrom according to JIS K 7139 (2009) Type A1 and subjected to measurement of the weight difference between before and after 24-hour immersion in water at 23° C. shows a water absorption rate of 0.26% to 0.50% as calculated by equation (3):

$$Water absorption rate ( \% ) = \frac{\begin{matrix}( weight in water absorbed state ) - \\ ( weight in absolute dry state )\end{matrix}}{( weight in absolute dry state )} \times 100. \qquad ( 3 )$$

[7] The resin composition as described in any one of [1] to [6], wherein the polyolefin resin (a) gives a molded product having a bending elastic modulus of 0.5 to 1.3 GPa.
[8] The resin composition as described in any one of [1] to [7], wherein the polyamide resin (b) gives a molded product having a bending elastic modulus of 2.5 to 3.0 GPa.
[9] The resin composition as described in any one of [1] to [8], wherein the modified polyolefin resin (a-1) and the unmodified polyolefin resin (a-2) account for 1 to 46 wt % and 99 to 54 wt %, respectively, relative to the total weight of the modified polyolefin resin (a-1) and the unmodified polyolefin resin (a-2), which accounts for 100 wt %.
[10] A molded resin product produced from the resin composition as defined in any one of [1] to [9].

We provide a resin composition having both high level fuel permeation resistance and high weldability to welding material (polyolefin resin), and a molded resin product that is produced from the resin composition and is free of surface stripping and high in moldability.

### BRIEF DESCRIPTION OF THE DRAWINGS

FIG. 1 is a diagram showing the shape of the test piece used for evaluation based on infrared microspectrometry analysis and the observed portion.

FIG. 2 is a diagram showing the shape of the test piece used for evaluation of weldability to welding material.

FIG. 3 is a diagram showing the shape of the testing tool used for fuel permeation resistance evaluation.

FIG. 4 is a diagram showing the shape of the test piece used for moldability evaluation and the observed portion.

### EXPLANATION OF NUMERALS

1. observed position
2. molded resin product produced from the resin composition
3. molded resin product produced from high density polyethylene
4. molded resin product produced from the resin composition
5. (toluene/isooctane =50/50 vol %) +E10 (ethanol 10 vol %)
6. metal screw
7. aluminum cup
8. observed position
9. gate
10. test piece

### DETAILED DESCRIPTION

Examples of our compositions and molded articles are described in detail below. This disclosure is not limited to the examples described below and may be modified appropriately within the scope of the appended claims.

In the polyamide resin composition, the polyolefin resin (a) and the polyamide resin (b) account for 70 to 30 wt % and 30 to 70 wt %, respectively, relative to the total weight of the polyolefin resin (a) and the polyamide resin (b), which accounts for 100 wt %, and the surface of a molded resin product produced from the resin composition and analyzed by infrared microspectrometry gives a spectrum peak intensity ratio of 3.0 to 5.0 as calculated by equation (1) specified above.

Each component used to prepare the polyamide resin composition is described below.

The polyolefin resin (a) is a thermoplastic resin that is produced through polymerization or copolymerization of olefins such as ethylene, propylene, butene, isoprene, and pentene. More specifically, useful ones include homopolymers such as polyethylene, polypropylene, polystyrene, polyacrylate, polymethacrylate, poly(1-butene), poly(1-pentene), and polymethylpentene; ethylene/α-olefin copolymers; vinyl alcohol ester homopolymers; polymers produced through hydrolysis of at least parts of vinyl alcohol ester homopolymers; [polymers produced through hydrolysis of at least parts of copolymers between (ethylene and/or propylene) and vinyl alcohol ester]; [copolymers between (ethylene and/or propylene) and (unsaturated carboxylic acid and/or unsaturated carboxylate)]; [copolymers produced by converting at least parts of carboxyl groups in copolymers between (ethylene and/or propylene) and (unsaturated carboxylic acid and/or unsaturated carboxylate) into metal salts]; and block copolymers between conjugated dienes and vinyl aromatic hydrocarbons, and hydrides of such block copolymers.

In particular, polyethylene, polypropylene, ethylene/α-olefin copolymers, [copolymers between (ethylene and/or propylene) and (unsaturated carboxylic acid and/or unsaturated carboxylate)], and [copolymers produced by converting at least parts of carboxyl groups in copolymers between (ethylene and/or propylene) and (unsaturated carboxylic acid and/or unsaturated carboxylate) into metal salts] are preferred.

An ethylene/α-olefin copolymer as referred to herein is a copolymer between ethylene and at least one or more α-olefins having 3 to 20 carbon atoms, and specific examples of such α-olefins having 3 to 20 carbon atoms include propylene, 1-butene, 1-pentene, 1-hexene, 1-heptene, 1-octene, 1-nonene, 1-decene, 1-undecene, 1-dodecene, 1-tridecene, 1-tetradecene, 1-pentadecene, 1-hexadecene, 1-heptadecene, 1-octadecene, 1-nonadecene, 1-eicosene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3 -ethyl-1-hexene, 9-methyl-1-decene, 11-methyl-1-dodecene, 12-ethyl-1-tetradecene, and combinations thereof. Of the copolymers containing these α-olefins, those containing α-olefins having 3 to 12 carbon atoms are preferred from the viewpoint of ensuring higher mechanical strength. It is preferable for such an ethylene/α-olefin type copolymer to have an α-olefin content of 1 to 30 mol %, more preferably 2 to 25 mol %, and still more preferably 3 to 20 mol %.

In addition, at least one nonconjugated diene selected from the group consisting of 1,4-hexadiene, dicyclopentadiene, 2,5-norbornadiene, 5-ethylidene norbornene, 5-ethyl-2,5-norbornadiene, 5-(1′-propenyl)-2-norbornene may be copolymerized.

Furthermore, the unsaturated carboxylic acid used in the [copolymers between (ethylene and/or propylene) and (unsaturated carboxylic acid and/or unsaturated carboxylate)] is either an acrylic acid or a methacrylic acid, or a mixture thereof. Preferred examples of the unsaturated carboxylate include the methyl ester, ethyl ester, propyl ester, butyl ester, pentyl ester, hexyl ester, heptyl ester, octyl ester, nonyl ester, and decyl ester of the unsaturated carboxylic acid, and mixtures thereof. It is particularly preferable to use a copolymer of an ethylene and methacrylic acid or a copolymer of an ethylene, methacrylic acid, and acrylate.

Of these examples of the polyolefin resin (a), preferred ones include low, medium, and high density polyethylenes, polypropylene, and ethylene/α-olefin copolymers. It is more preferable to adopt a low, medium, or high density polyethylene. From the viewpoint of durability in terms of fuel permeation resistance and heat resistance, it is particularly preferable to adopt a high density polyethylene having a density of 0.94 to 0.97 g/cm³.

It is preferable for the polyolefin resin (a) to have a melt flow rate (MFR, ASTM D1238) of 0.01 to 70 g/10 minutes. The MFR is more preferably 0.01 to 60 g/10 minutes. A MFR of less than 0.01 g/10 minutes leads to a low flowability. If it is more than 70 g/10 minutes, it may lead to a low impact strength depending on the shape of the molded resin product.

There are no specific limitations on the production method for a polyolefin resin (a) and available methods include radical polymerization, coordination polymerization using a Ziegler-Natta catalyst, anionic polymerization, and coordination polymerization using a metal-locene catalyst.

Furthermore, it is preferable for a part of or the entirety of the polyolefin resin (a) to be modified with at least one compound selected from unsaturated carboxylic acids and/or derivatives thereof. If such a modified polyolefin resin (a) is used, it improves the compatibility and enhance the impact resistance. Besides, molded resin products produced from the resulting resin composition tend to be free of surface stripping and high in moldability.

Unsaturated carboxylic acids and/or derivatives thereof that can be used as modifiers are as listed below: acrylic acid, methacrylic acid, maleic acid, fumaric acid, itaconic acid, crotonic acid, methylmaleic acid, methylfumaric acid, mesaconic acid, citraconic acid, glutaconic acid, metal salts of these carboxylic acids, methyl hydrogen maleate, methyl hydrogen itaconate, methyl acrylate, ethyl acrylate, butyl acrylate, 2-ethylhexyl acrylate, hydroxyethyl acrylate, methyl methacrylate, 2-ethylhexyl methacrylate, hydroxyethyl methacrylate, aminoethyl methacrylate, dimethyl maleate, dimethyl itaconate, maleic anhydride, itaconic anhydride, citraconic anhydride, endobicyclo-(2,2,1)-5-heptene-2,3-dicarboxylic acid, endobicyclo-(2,2,1)-5-heptene-2,3-dicarboxylic anhydride, maleimide, N-ethyl maleimide, N-butyl maleimide, N-phenyl maleimide, glycidyl acrylate, glycidyl methacrylate, glycidyl methacrylate, glycidyl itaconate, glycidyl citraconate, and 5-norbornene-2,3-dicarboxylic acid. Of these, unsaturated dicarboxylic acids and anhydrides thereof are preferred and maleic acid and maleic anhydride are particularly preferred.

It is preferable for the polyolefin resin (a) comprises a modified polyolefin resin (a-1) and an unmodified polyolefin resin (a-2).

In regard to the amount of the unsaturated carboxylic acid or a derivative thereof to be introduced as the modified polyolefin resin (a-1), the acid value (JIS K 0070 (1992)) of the modified polyolefin resin (a-1) is preferably in the range of 12 mgKOH/g to 35 mgKOH/g from the viewpoint of compatibility, moldability, weldability to welding material. If it is in this range, it ensures a high compatibility with the polyamide resin (b). In particular, the surface of a molded resin product that involves the polyolefin resin (a) component and the polyamide resin (b) component will have a stable phase structure. In addition, they tend to be high in retention stability in the molten state during a molding step or the like and less liable to viscosity increase under the influence of unreacted modifier molecules. Furthermore, the polyolefin resin (a) component in the resulting resin composition contains a reactive functional group that works to increase the weldability to welding material. If the acid value exceeds 35 mgKOH/g, the retention stability in the molten state during a molding step or the like is likely to decrease, possibly leading to an increase in viscosity. If it is less than 12 mgKOH/g, on the other hand, the weldability to welding material is likely to decrease. It is more preferably in the range of 14 mgKOH/g to 30 mgKOH/g, still more preferably 20 mgKOH/g to 25 mgKOH/g.

In regard to the ratio of the content of the unmodified polyolefin resin (a-2) to that of the modified polyolefin resin (a-1), it is preferable, from the viewpoint of fuel permeation resistance, that the modified polyolefin resin (a-1) and the unmodified polyolefin resin (a-2) account for 1 to 46 wt % and 99 to 54 wt %, respectively, relative to the total weight of the modified polyolefin resin (a-1) and the unmodified polyolefin resin (a-2), which accounts for 100 wt %. It is more preferable for them to account for 10 to 44 wt % and 90 to 56 wt %, respectively, still more preferably 20 to 42 wt % and 80 to 58 wt %, respectively. If the proportions are in these ranges, it allows the polyolefin resin (a) component and the polyamide resin (b) component to form a stable phase structure. As a result, the composition tends to be high in retention stability in the molten state during a molding step or the like. In addition, it is also possible to obtain a molded resin product in which the composition suffers little color changes such as yellowing.

The polyamide resin (b) contains an amino acid, a lactam, or a diamine in combination with a dicarboxylic acid as main constituent component. Examples of major constituent components include amino acids such as 6-aminocaproic acid, 11-aminoundecanoic acid, 12-aminododecanoic acid, and para-aminomethyl benzoic acid; lactams such as ε-caprolactam and ω-laurolactam; aliphatic, alicyclic, or aromatic diamines such as tetramethylene diamine, hexamethylene diamine, 2-methylpentamethylene diamine, nonamethylene diamine, undecamethylene diamine, dodecamethylene diamine, 2,2,4-/2,4,4-trimethylhexamethylene diamine, 5-methylnonamethylene diamine, meta-xylylene diamine, para-xylylene diamine, 1,3-bis(aminomethyl) cyclohexane, 1,4-bis(aminomethyl) cyclohexane, 1-amino-3-aminomethyl-3,5,5-trimethyl cyclohexane, bis(4-aminocyclohexyl) methane, bis(3-methyl-4-aminocyclohexyl) methane, 2,2-bis(4-aminocyclohexyl) propane, bis(aminopropyl) piperazine, and aminoethyl piperazine; and aliphatic, alicyclic, or aromatic dicarboxylic acids such as adipic acid, suberic acid, azelaic acid, sebacic acid, dodecanedioic acid, terephthalic acid, isophthalic acid, 2-chloroterephthalic acid, 2-methylterephthalic acid, 5-methylisophthalic acid, 5-sodium sulfoisophthalic acid, 2,6-naphthalene dicarboxylic acid, hexahydroterephthalic acid, and hexahydroisophthalic acid. Nylon homopolymers or copolymers induced from these materials may be used singly or as a mixture thereof.

Polyamide resins having melting points of 150° C. or more and having high heat resistance and high strength are particularly useful as the polyamide resin (b). Specific examples include polycaproamide (nylon 6), polyhexamethylene adipamide (nylon 66), polytetramethylene adipamide (nylon 46), polyhexamethylene sebacamide (nylon 610), polyhexamethylene dodecamide (nylon 612), polyundecane amide (nylon 11), polydodecane amide (nylon 12), polycaproamide/polyhexamethylene adipamide copolymer (nylon 6/66), polycaproamide/polyhexamethylene terephthalamide copolymer (nylon 6/6T), polyhexamethylene adipamide/polyhexamethylene terephthalamide copolymer (nylon 66/6T), polyhexamethylene adipamide/polyhexamethylene isophthalamide copolymer (nylon 66/61), polyhexamethylene terephthalamide/polyhexamethylene isophthalamide copolymer (nylon 6T/6I), polyhexamethylene terephthalamide/polydodecanamide copolymer (nylon 6T/12), polyhexamethylene adipamide/polyhexamethylene terephthalamide/polyhexamethylene isophthalamide copolymer (nylon 66/6T/6I), polyxylylene adipamide (nylon XD6), polyhexamethylene terephthalamide/poly-2-methylpentamethylene terephthalamide copolymer (nylon 6T/M5T), polynonamethylene terephthalamide (nylon 9T), and mixtures thereof.

In particular, nylon 6, nylon 66, nylon 610, nylon 6/66 copolymers, and copolymers containing the hexamethylene terephthalamide unit such as nylon 6T/66 copolymer, nylon 6T/6I copolymer, nylon 6T/12, and nylon 6T/6 copolymer are preferable as the polyamide resin (b). Of these, nylon 6 is particularly preferable. The use of nylon 6 is suitable in terms of the realization of both fuel permeation resistance and weldability to welding material. It is also practically suitable to mix a plurality of these polyamide resins to develop required characteristics including impact resistance, moldability, and compatibility.

There are no specific limitations on the polymerization degree of the polyamide resin (b), but it preferably has a relative viscosity of 1.5 to 7.0 as measured at 25° C. in a 98% concentrated sulfuric acid solution with a sample concentration of 0.01 g/ml. In particular, it is preferable for the polyamide resin to have a relative viscosity of 2.0 to 6.0 as measured at 25° C.

Furthermore, the polyamide resin (b) may suitably contain a copper compound with the aim of improving the long-term heat resistance. Specific examples of the copper compound include cuprous chloride, cupric chloride, cuprous bromide, cupric bromide, cuprous iodide, cupric iodide, cupric sulfate, cupric nitrate, copper phosphate, cuprous acetate, cupric acetate, cupric salicylate, cupric stearate, cupric benzoate, and complex compounds of aforementioned inorganic copper halides with xylylene diamine, 2-mercaptobenzimidazole, or benzimidazole. Among others, monovalent copper compounds, monovalent copper halide compounds in particular, are preferable, and preferred copper compounds include cuprous acetate and cuprous iodide. It is commonly preferable for such a copper compound to account for 0.01 to 2 parts by weight, more preferably 0.015 to 1 part by weight, relative to 100 parts by weight of the polyamide resin (b). If its content is too large, metallic copper is likely to be liberated during melt-molding to cause coloring, leading to a decrease in product value. An alkali halide may be added for use in combination with a copper compound. Examples of such an alkali halide compound include lithium chloride, lithium bromide, lithium iodide, potassium chloride, potassium bromide, potassium iodide, sodium bromide, and sodium iodide, of which potassium iodide and sodium iodide are particularly preferable.

In regard to the contents of the polyolefin resin (a) and the polyamide resin (b) in a resin composition, the polyolefin resin (a) and the polyamide resin (b) preferably account for 30 to 70 wt % and 70 to 30 wt %, respectively. It is more preferable for the polyolefin resin (a) and the polyamide resin (b) to account for 40 to 60 wt % and 60 to 40 wt %, respectively. If the content of the polyolefin resin (a) is less than 30 wt %, it is impossible to form a phase structure having a specific higher order structure. As a result, the proportion of the polyolefin resin (a) component existing in the surface of a molded resin product produced will decrease, making it difficult to form a phase structure that gives a spectrum peak intensity ratio as represented by the equation (1). Thus, it will be difficult to meet the desired objects. On the other hand, if the content of the polyolefin resin (a) is more than 70 wt %, it leads to deterioration in fuel permeation resistance and mechanical characteristics such as heat resistance and strength.

The method to produce the resin composition is not particularly limited, but, for ex-ample, a good method is to melt-knead the polyolefin resin (a) and the polyamide resin (b) in a twin screw extruder.

In addition, other resins may also be contained unless they impair the desired effects.

A molded resin product produced from the resin composition may contain an inorganic filler to develop mechanical strength, rigidity, or fuel permeation resistance. There are no specific limitations on the material, and it may be good to use fillers in fibrous, plate-like, powdery, or particulate forms. Specific examples include fibrous fillers such as glass fiber, carbon fiber, potassium titanate whisker, zinc oxide whisker, alumina fiber, silicon carbide fiber, ceramic fiber, asbestos fiber, gypsum fiber, and metal fiber; silicates such as wollastonite, sericite, kaolin, mica, clay, bentonite, asbestos, talc, and alumina silicate; swellable layered silicates such as montmorillonite and synthetic mica; metal compounds such as alumina, silicon oxide, magnesium oxide, zirconium oxide, titanium oxide, and iron oxide; carbonates such as calcium carbonate, magnesium carbonate, and dolomite; sulfates such as calcium sulfate and barium sulfate; and non-fibrous fillers such as glass beads, ceramic beads, boron nitride, silicon carbide, calcium phosphate, and silica. These fillers may be in a hollow form and two or more thereof may be used in combination.

In addition, to realize better mechanical strength and fuel permeation resistance, it is good to use these inorganic fillers after pre-treating them with a coupling agent such as an isocyanate based compound, organic silane based compound, organic titanate based compound, organic borane based compound, or epoxy compound. In swellable layered silicates, it is good to perform pre-treatment with organic onium ions.

It is preferable for the above fillers to account for 0.1 part by weight or more and 200 parts by weight or less relative to the total weight of the polyolefin resin (a) and the polyamide resin (b), which accounts for 100 parts by weight. The lower limit is more preferably 0.5 part by weight or more, and particularly preferably 1 part by weight or more. The upper limit, on the other hand, is preferably 200 parts by weight or less, particularly preferably 150 parts by weight or less.

The composition may contain other components unless they impair advantageous effects and they include, for example, antioxidant agents and heat-resistant stabilizers (such as hindered phenol based, hydroquinone based, and phosphite based ones, and substitution products thereof), weathering stabilizers (such as resorcinol based, salicylate based, benzotriazole based, benzophenone based, and hindered amine based ones), mold release agents and lubricants (such as montanic acids, metal salts thereof, esters thereof, and half esters thereof, as well as stearyl alcohols, stearamide, various bisamides, bisurea, and polyethylene wax), pigments (such as cadmium sulfide, phthalocyanine, and carbon black), dyes (such as nigrosine), crystal nucleating agents (such as talc, silica, kaolin, and clay), plasticizers (such as octyl p-oxybenzoate and N-butylbenzene sulfoneamide), antistatics (such as alkyl sulfate type anionic antistatics, quaternary ammonium salt type cationic antistatics, and polyoxyethylene sorbitan monostearates, other similar nonionic antistatics, and betaine based amphoteric antistatics), flame retardants (such as red phosphorus, melamine cyanurate, magnesium hydroxide, aluminum hydroxide, other hydroxides, ammonium polyphosphate, brominated polystyrene, brominated polyphenylene ether, brominated polycarbonate, brominated epoxy resin, and combinations of these bromine based flame retardants with antimony trioxide), and other polymers.

A molded resin product produced from the resin composition is preferably in the form of a molded body partly and entirely constituted of a phase structure in which the polyolefin resin (a) component forms a continuous phase (matrix phase) and the polyamide resin (b) component forms a continuous phase (matrix phase) in the thickness direction. To examine this phase structure, a cut surface of the molded product is observed by scanning or transmission electron microscopy.

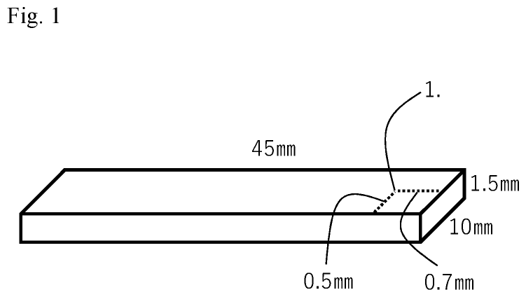

Furthermore, the desired effects can be obtained by increasing the amount of the polyolefin resin (a) component existing in the surface of the molded resin product produced from the resin composition. The surface of a molded resin product referred to herein means the outer layer of the molded product. More specifically, the layer which extends from the surface of the molded product to a depth of 10 μm or less measured in the thickness direction. Its existence in a large amount in this region works also to increase the stability of the phase structure in the thickness direction of the molded resin product. The proportion of the polyolefin resin (a) component existing in the surface can be determined by infrared microspectrometry analysis. Specifically, the proportion of the polyolefin resin (a) component spreading in the surface of the molded resin product can be determined on the basis of a comparison in absorbance between specific peaks of the polyolefin resin (a) and the polyamide resin (b). A detailed procedure is described below. To represent a molded resin product, a test piece (having a shape according to ISO 19095-2 (2015) Type B) illustrated in FIG. 1 is prepared by injection molding (SE50DU, manufactured by Sumitomo Heavy Industries, Ltd., cylinder temperature 260° C., die temperature 80° C., injection speed 20 mm/s). A portion located near the flow-directional end as illustrated in FIG. 1 (“1” in FIG. 1 located at a position 0.7 mm from the flow-directional end of the molded product and 0.5 mm in the width direction of the molded product) is examined on the basis of an infrared absorption spectrum from a specific region (300 μm×300 μm) of the surface of the molded resin product observed by attenuated total reflection (ATR) infrared spectroscopy (Fourier transform infrared microspectrometry). Observation was performed under the conditions of an aperture size of 50 μm×50 μm, a resolution of 8 cm⁻¹, and 100 measuring runs to determine the absorbance near 2,950 cm⁻¹ and the absorbance near 3,300 cm⁻¹. The absorbance near 2,950 cm⁻¹ means the measurement at the peak showing the strongest absorbance in the range of 2,850 cm⁻¹ to 3,050 cm⁻¹ while the absorbance near 3,300 cm⁻¹ means the measurement at the peak showing the strongest absorbance in the range of 3,200 cm⁻¹ to 3,400 cm⁻¹. The peak intensity ratio, which is calculated by the equation (1), averaged over the 300 μm×300 μm area should be 3.0 or more 5.0 or less. If it is in this range, the polyolefin resin (a) component exists in a large amount in the surface of the molded resin product, and its molecules spread and undergo entanglement in the weld interface with welding material to realize a high weldability. The lower limit is more preferably 3.2 or more, still more preferably 3.5 or more. On the other hand, the upper limit is more preferably 4.8 or less, still more preferably 4.5 or less. If it is less than 3.0, the polyolefin resin (a) component appears in a smaller amount in the surface of the molded resin product, leading to deterioration in weldability to welding material. If it is more than 5.0, the polyolefin resin (a) component appears in an excessive amount in the surface of the molded resin product and as a result, the polyolefin resin (a) component in the surface absorbs fuel and spreads, leading to deterioration in fuel permeation resistance. In addition, the amount of the polyamide resin (b) component, which is higher in elastic modulus, existing in the surface decreases and its effect of strengthening the interface to welding material is lost, resulting in deterioration in weldability. Furthermore, as an influence of the polyolefin resin (a) component, which has a lower crystallization temperature, increased transcription occurs during the molding step and the resin is caught on the die to cause deterioration in releasability. As a result, the molded resin product will suffer surface stripping or the like.

A molded resin product can be produced from the resin composition by, for example, the procedure described below.

In general, a molded resin product is produced by melt-molding from the resin com-position, and during the melt-molding, differences in temperature and stress can occur easily be-tween the surface of the molded resin product and the interior of the molded resin product while it is flowing. In regard to the interior of the molded resin product referred to herein, the interior of the molded resin product means the region covering 45% to 55% of the depth from the surface of the molded resin product relative to the total thickness of the molded resin product, which accounts for 100%. To make effective use of this feature, we adopt resins differing in melt viscosity dependence on shear rate as the polyolefin resin (a) and the polyamide resin (b). If a difference in shear rate occurs between the surface of the molded resin product and the interior of the molded resin product, it works to form a matrix phase of the polyolefin resin (a) component in the surface of the molded resin product. The melt viscosity ratio defined by the equation (2) given above is preferably 0.35 or more and 0.64 or less when the shear rate is 1,216 second⁻¹ at a temperature of Tp+20° C., wherein Tp (° C.) represents the melting point of the polyolefin resin (a) or that of the polyamide resin (b), whichever is the higher. The lower limit is more preferably 0.40 or more, still more preferably 0.45 or more. If it is in this range, the polyolefin resin (a) component, which is high in weldability to welding material (polyolefin resin), tends to spread in the surface of a molded resin product produced from the resin composition whereas the polyamide resin (b) component, which is high in fuel permeation resistance, tends to spread in the interior. In addition, such a distribution is likely to serve to simultaneously realize both high weldability to welding material and high fuel permeation resistance. If it is more than 0.64, furthermore, the molded resin product is likely to suffer molding defects such as surface stripping.

When the polyolefin resin (a) is composed of a plurality of components, the melt viscosity of each polyolefin resin (a) component is multiplied by the weight fraction of each component relative to the entire polyolefin resin (a), and the products are summed up to determine the overall melt viscosity of the polyolefin resin (a). More specifically, it is calculated by equation (4):

$$Overall melt viscosity of polyolefin resin ( Pa \cdot s ) = {\sum }_{i = 1}^{n} \frac{{MO}_{i}}{MO} \cdot {VO}_{i} . \qquad ( 4 )$$

MO is the total proportion (wt %) of the entire polyolefin resin (a); MOᵢ is the proportion (wt %) of each polyolefin resin (a) component; and VOᵢ is the melt viscosity (Pa s) of each polyolefin resin (a) component. In addition, n represents the number of the polyolefin resin (a) components used as input materials.

When the polyamide resin (b) is composed of a plurality of components, the melt viscosity of each polyamide resin (b) component is multiplied by the weight fraction of each component relative to the entire polyamide resin (b), and the products are summed up to determine the overall melt viscosity of the polyamide resin (b). More specifically, it is calculated by equation (5):

$$Overall melt viscosity of polyamide resin ( Pa \cdot s ) = {\sum }_{i = 1}^{n} \frac{{MA}_{i}}{MA} \cdot {VA}_{i} . \qquad ( 5 )$$

MA is the total proportion (wt %) of the entire polyamide resin (b); MAᵢ is the proportion (wt %) of each polyamide resin (b) component; and VAᵢ is the melt viscosity (Pa s) of each polyamide resin (b) component. In addition, n represents the number of polyamide resin (b) components used as input materials.

Measurement of the water absorption rate of a molded resin product produced from the resin composition gives an indicator serving to control the phase structure of the molded resin product produced from the resin composition. If a molded resin product produced from the resin composition has a high water absorption rate, it suggests that the polyamide resin (b) component, which is hydrophilic, exists in a large amount in the surface of the molded resin product, whereas if the water absorption rate is low, it suggests that the polyolefin resin (a) component, which is hydrophobic, exists in a large amount in the surface of the molded resin product.

The test piece produced from the resin composition preferably has a water absorption rate of 0.26% or more and 0.50% or less. If the water absorption rate is less than 0.26%, the fuel permeation resistance deteriorates. To realize further improvement in fuel permeation resistance, it is more preferable for the water absorption rate to be 0.29% or more, still more preferably 0.32% or more. If the water absorption rate is more than 0.50%, on the other hand, the weldability to welding material decreases. To realize further improvement in weldability, it is more preferable for the water absorption rate to be 0.46% or less, still more preferably 0.42% or less. To give a specific method to measure the water absorption rate, a test piece prepared by injection molding or the like is vacuum-dried (80° C., 14 hours, vacuum of 1,013 hPa) to absolute dryness (absolute dry state) and then immersed in water at 23° C. for 24 hours, followed by determining the weight increase rate as the ratio of the weight in the water absorbed state to that in the absolute dry state. The test piece to use here is a dumbbell shaped one according to JIS K 7139 (2009) Type A1 having an overall length of 170 mm, a parallel part length of 80 mm, a parallel part width of 10 mm, and a thickness of 4 mm. In regard to the calculation method, the water absorption rate should be calculated by equation (3) above.

From the viewpoint of weldability to welding material, the molded product produced from the polyolefin resin (a) preferably has a bending elastic modulus of 0.5 to 1.3 GPa. In regard to the measuring method, it is calculated based on three point bending test according to ISO 178 (2013). If the bending elastic modulus is less than 0.5 GPa, the resulting resin composition decreases in rigidity, leading to deterioration in weldability to welding material. If the bending elastic modulus is more than 1.3 GPa, stress concentration is likely to occur at the weld interface between the molded resin product produced from the resin composition and welding material, leading to deterioration in weldability. When the polyolefin resin (a) is composed of a plurality of components, furthermore, the bending elastic modulus of each polyolefin resin (a) component is multiplied by the weight fraction of each component relative to the entire polyolefin resin (a), and the products are summed up to determine the overall bending elastic modulus of the polyolefin resin (a). More specifically, it is calculated by equation (6):

$$Overall bending elastic modulus of polyolefin resin ( GPa ) = {\sum }_{i = 1}^{n} \frac{{MO}_{i}}{MO} \cdot {X}_{i} . \qquad ( 6 )$$

MO is the total proportion (wt %) of the entire polyolefin resin (a); MO, is the proportion (wt %) of each polyolefin resin (a) component; and X, is the bending elastic modulus (GPa) of each polyolefin resin (a) component. In addition, n represents the number of the polyolefin resin (a) components used as input materials.

From the viewpoint of weldability between the resin composition and welding material, the molded product produced from the polyamide resin (b) preferably has a bending elastic modulus of 2.5 to 3.0 GPa. In regard to the measuring method, it is calculated based on three point bending test according to ISO 178 (2013). If the bending elastic modulus is less than 2.5 GPa, the resulting resin composition decreases in rigidity, leading to deterioration in weldability to welding material. If the bending elastic modulus is more than 1.3 GPa, stress concentration is likely to occur at the weld interface between the molded resin product produced from the resin composition and welding material, leading to deterioration in weldability. When the polyamide resin (b) is composed of a plurality of components, furthermore, the bending elastic modulus of each polyamide resin (b) component is multiplied by the weight fraction of each component relative to the entire polyamide resin (b), and the products are summed up to determine the overall bending elastic modulus of the polyamide resin (b). More specifically, it is calculated by equation (7):

$$Overall bending elastic modulus of polyamide resin ( GPa ) = {\sum }_{i = 1}^{n} \frac{{MA}_{i}}{MA} \cdot {Y}_{i} . \qquad ( 7 )$$

MA is the total proportion (wt %) of the entire polyamide resin (b); MA, is the proportion (wt %) of each polyamide resin (b) component; and Y, is the bending elastic modulus (GPa) of each polyamide resin (b) component. In addition, n represents the number of polyamide resin (b) components used as input materials.

There are various examples of the molded resin product having different shapes. To produce melt-molded products, in particular, there are various generally known useful molding methods including injection molding, extrusion molding, blow molding, and press molding. Of these, the use of injection molding, injection compression molding, or compression molding is preferable to easily achieve the desired objects. In regard to the molding temperature, furthermore, a temperature in the range higher by 5° C. to 50° C. than the melting point of the polyamide resin (b) is adopted commonly.

Various structures can be produced by different molding methods. They are mostly monolayered, but they may be multi-layered structures produced by the two color injection molding method, co-extrusion molding method and the like. Those produced by the two color injection molding method, co-extrusion molding method and the like, have good adhesion properties. A multi-layered structure as referred to here is one having a molded resin product in at least one of the layers. The arrangement of the layers is not particularly limited, and all layers may be formed of molded resin products, or some of the layers may be formed of other thermoplastic resins.

Such a multi-layered structure can be produced by the two color injection molding method and the like, but when a film-like or sheet-like one is to be produced, it may be good to adopt a procedure in which compositions designed to form different layers are melted in separate extruders and then supplied to a multi-layered die to perform co-extrusion molding or a procedure in which layers of other resins are molded first and a layer of a molded resin product is melt-extruded in a so-called laminate molding process. To produce a layered structure in the form of a hollow container such as bottle, barrel, and tank, or a tubular structure such as pipe and tube, the common co-extrusion molding method can be adopted and, for example, a two-layered hollow molded product composed of an inner layer formed of a molded resin product and an outer layer formed of other resin can be produced by supplying the molded resin product composition and the other resin composition to two separate extruders and sending these two molten resin streams under pressure to a die to form separate annular streams, which are combined such that an inner layer is formed from the molded resin product while an outer layer is formed from the other resin, followed by co-extruding them out of the die and processing them into a two-layered hollow molded product by the generally known tube molding method, blow molding method and the like. In producing a three-layer hollow molded product, a similar procedure to the above one may be carried out to form a three-layer structure using three extruders, or a hollow molded product having a two-resin three-layer structure can be produced by using two extruders. Among these methods, it is preferable to perform molding by the co-extrusion molding method from the viewpoint of interlaminar adhesive strength.

Examples of thermoplastic resins used for the other layer described above include saturated polyester, polysulfone, polytetrafluoroethylene, polyetherimide, polyamide-imide, polyamide resin, polyketone copolymer, polyphenylene ether, polyimide, polyethersulfone, polyether ketone, polythioether ketone, polyether ether ketone, thermoplastic polyurethane, polyolefin resin, ABS, polyamide elastomer, and polyester elastomer, which may be used as a mixture or may contain various additives.

With high permeation resistance, durability, and moldability, the molded resin product can be used suitably to form containers for gas and/or liquid conveyance or storage or attached parts thereof. Examples of such gas and liquid include Freon-11, Freon-12, Freon-21, Freon-22, Freon-113, Freon-114, Freon-115, Freon-134a, Freon-32, Freon-123, Freon-124, Freon-125, Freon-143a, Freon-141b, Freon-142b, Freon-225, Freon-C318, R-502, 1,1,1-trichloroethane, methyl chloride, methylene chloride, ethyl chloride, methyl chloroform, propane, isobutane, n-butane, dimethyl ether, castor oil based brake fluid, glycol ether based brake fluid, boric acid ester based brake fluid, brake fluid for cold areas, silicone oil based brake fluid, mineral oil based brake fluid, power steering oil, wind washer fluid, gasoline, kerosene, light oil, heavy oil, toluene, isooctane, methanol, ethanol, isobutanol, butanol, nitrogen, oxygen, hydrogen, carbon dioxide, methane, propane, natural gas, argon, helium, xenon, and medical drugs. With high resistance to permeation of such gases, liquids, and evaporated gases, it serves for the production of various articles including, for example, gas and/or liquid permeation resistant films, air bags, bottles for various medical liquids such as shampoo, conditioner, liquid soap, and detergent, chemicals storage tanks, gas storage tanks, coolant fluid tanks, oil transfusion tanks, antiseptic solution tanks, blood transfusion pump tanks, fuel tanks, canisters, washer fluid tanks, oil reservoir tanks, other automobile parts, parts of medical care tools, tanks used as tools for daily living, bottle-shaped molded resin products, cut-off valve covers, ORVR valve covers, other valves and joints attached to such tanks and bottles, gages, cases, and other parts of attached pumps, connection parts (connectors) of various fuel tubes such as fuel filler under-pipes, ORVR hoses, reserve hoses, and vent hoses, connection parts of oil tubes, connection parts of brake hoses, nozzles for wind washer fluid, connection parts of cooler hoses for cooling water, refrigerant, connection parts for air conditioner refrigerant tubes, connection parts of floor heating pipes, hoses for extinguishers and extinguishing equipment, connection parts and valves for medical cooling instrument tubes, tubes for conveyance of other chemicals and gas, chemicals storage containers, other articles requiring resistance to permeation of chemicals, automobile parts, parts of internal combustion engines, mechanical parts of electric power tool housing, other electric/electronic parts, articles for medical care, foodstuffs, and domestic/office, building material related parts, furniture parts, and other various articles.

### EXAMPLES

Our compositions and molded articles are described in more detail below with reference to examples. First, the evaluation procedures used in the examples and comparative examples are described.

### (1) Water Absorption Capacity

A dumbbell shaped test piece (JIS K 7139 (2009) Type A1) having an overall length of 170 mm, a parallel part length of 80 mm, a parallel part width of 10 mm, and a thickness of 4 mm was prepared by injection molding (N560-9A, manufactured by Nissei Plastic Industrial Co., Ltd., cylinder temperature 250° C., die temperature 80° C., injection speed 24 mm/s, filling time 1.6 sec.). The test piece was vacuum-dried (80° C., 14 hours, vacuum of 1,013 hPa) to absolute dryness (absolute dry state) and then immersed in water at 23° C. for 24 hours, followed by measuring the weight. The water absorption rate was calculated by equation (3) above.

The smaller the value of water absorption rate is, the lower the water absorption capacity it indicates.

### (2) Fuel Permeation Resistance

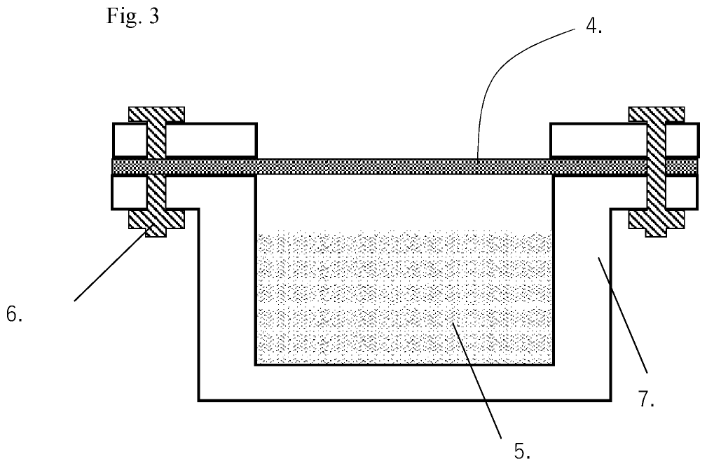

A square plate having a length of 80 mm, a width of 80 mm, and a thickness of 1 mm was molded by injection molding (NEX1000, manufactured by Nissei Plastic Industrial Co., Ltd., cylinder temperature 270° C., die temperature 80° C., injection speed 60 mm/s) and a disk having a diameter of 75 mm was cut out. About 4.6 g of a mixture of Fuel C (toluene/isooctane=50/50 vol %) and E10 (ethanol 10 vol %) was poured in an aluminum cup as illustrated in FIG. 3 and the disk-like test piece was attached and fixed with metal screws to ensure airtightness. Then, the cup was placed in an oven at 60° C. with the test piece up to anneal the test piece. The change in weight of the test piece was measured and the fuel permeability (g/(m² 24 hr)) was calculated according to JIS Z 0208. The smaller the value of fuel permeability is, the higher resistance to fuel permeation it indicates.

### (3) Weldability

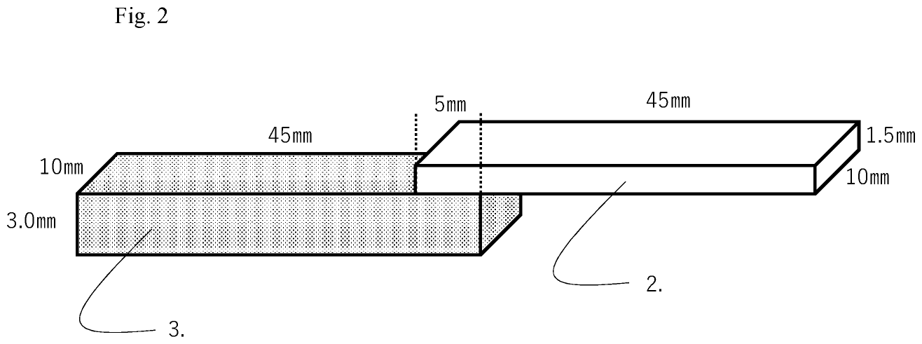

A strip shaped test piece having a length of 45 mm, a width of 10 mm, and a thickness of 1.5 mm was molded by injection molding (SE50DU, manufactured by Sumitomo Heavy Industries, Ltd., cylinder temperature 260° C., die temperature 80° C., injection speed 20 mm/s). Then, as a secondary material, high density polyethylene (MFR 5.8 g/10 min at 190° C. under a load of 2.16 kg, density 953 kg/m³ as measured according to ISO 1183 (2013)) was injection-welded (SE50DU, manufactured by Sumitomo Heavy Industries, Ltd., cylinder temperature 270° C., die temperature 80° C., injection speed 20 mm/s, weld area approx. 5 x 10⁻⁵ mm) to the injection-molded strip shaped test piece prepared above to provide a test piece as illustrated in FIG. 2. Using a metal jig designed to fix the resulting test piece (having a shape as specified in ISO 19095-2 (2015) Type B) such that the interface between the primary material and the secondary material was maintained parallel to the tensile direction, tensile test (Autograph AG-500C, manufactured by Shimadzu Corporation, tension speed 5 mm/min) was performed to measure the maximum load (N) generated during this test, which was defined as welding force and used for weldability evaluation.

### (4) Moldability

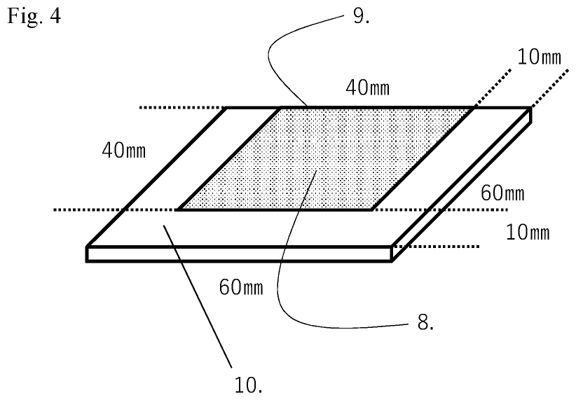

A square plate (film gate) having a length of 60 mm, a width of 60 mm, and a thickness of 1 mm was molded by injection molding (NEX1000, manufactured by Nissei Plastic Industrial Co., Ltd., cylinder temperature 260° C., die temperature 80° C., injection speed 140 mm/s) and this molded resin product was used as a test piece. A 40 mm×40 mm square portion of this test piece located near the gate (indicated by “8” in FIG. 4) was observed under a digital microscope (Digital Microscope VHX-900, manufactured by Keyence Corporation, magnification 5×), and the proportion of the area suffering surface stripping to the entire observed area (entire observed area being a 40 mm×40 mm square and accounting for 100%) was used as an indicator of moldability for evaluation in ratings A to C described below. Surface stripping means a state in which part of the polyolefin resin (a) component and/or the polyamide resin (b) component come off from the surface of the molded product or cause swelling and whitening. Specifically, the criterion adopted for the evaluation was as follows: (A) the area suffering surface stripping accounts for less than 1% of the entire observed area, (B) the area suffering surface stripping accounts for 1% or more and less than 15% of the entire observed area, and (C) the area suffering surface stripping accounts for 15% or more of the entire observed area.

### (5) Melt Viscosity Ratio

Using a capillary rheometer (Capilograph 1D, manufactured by Toyo Seiki Seisakusho, Ltd.), the melt viscosity (Pa s) at a shear rate of 1,216 second⁻¹ was measured at a temperature of Tp+20° C., wherein Tp (° C.) represents the melting point of the polyolefin resin (a) or that of the polyamide resin (b), whichever is the higher, and the melt viscosity ratio was calculated by equation (2) above.

### (6) Acid Value

Measurements were taken according to JIS K 0070 (1992). First, 1 g of the modified polyolefin resin (a-1) was weighed accurately and put in 100 mL of xylene, followed by stirring at about 120° C. to ensure dissolution. After confirming complete dissolution, a phenolphthalein solution was added and neutralization titration was performed with a 0.1 mol/L potassium hydroxide-ethanol solution, which had a concentration accurately determined in advance, followed by calculating the acid value.

### (7) Bending Elastic Modulus

According to JIS K7139 (2009) Type A1, a dumbbell shaped test piece (JIS K 7139 (2009) Type A1) having an overall length of 170 mm, a parallel part length of 80 mm, a parallel part width of 10 mm, and a thickness of 4 mm was prepared by injection molding (NS60-9A, manufactured by Nissei Plastic Industrial Co., Ltd., cylinder temperature 30° C. above melting point of each resin, die temperature 80° C., injection speed 24 mm/s, filling time 1.6 sec.). The test piece was vacuum-dried (80° C., 14 hours, vacuum of 1,013 hPa) to absolute dryness (absolute dry state) and then subjected to three-point bending test with a support interval of 64 mm according to ISO 178 (2013) to determine the bending elastic modulus of the molded product produced from the polyolefin resin (a) and that from the polyamide resin (b). When the polyolefin resin (a) is composed of a plurality of components, the bending elastic modulus of a molded product produced from each polyolefin resin (a) component is measured, and the measurements taken were used to calculate the bending elastic modulus of a molded product produced from the entire polyolefin resin (a) by equation (6) above.

### (8) Infrared Microspectrometry Analysis

A test piece as shown in FIG. 1 was prepared by injection molding (SE50DU, manufactured by Sumitomo Heavy Industries, Ltd., cylinder temperature 260° C., die temperature 80° C., injection speed 20 mm/s). For infrared microspectrometry analysis, an infrared absorption spectrum (Fourier transform infrared microspectrometry) from a specific region (300 μm×300 μm) located at the position “1” in FIG. 1 (0.7 mm from the flow-directional end of the molded product and 0.5 mm in the width direction of the molded product) was observed by attenuated total reflection infrared spectroscopy (ATR method). The peak intensity ratio was calculated by equation (1) above from absorbance measurements taken near 2,950 cm⁻¹ and 3,300 cm⁻¹. Analysis was performed under the conditions of an aperture size of 50 μm×50 μm, a resolution of 8 cm⁻¹, and 100 measuring runs.

### (9) Mixing Ratio (Proportion) of Modified Polyolefin Resin (a-1)

The mixing ratio (proportion) of the modified polyolefin resin (a-1) was calculated by equation (8) wherein the modified polyolefin resin (a-1) and the unmodified polyolefin resin (a-2) account for 100 wt % in total:

$$Proportion of modified polyolefin resin ( \% ) = \frac{( proportion of modified polyolefin resin )}{\begin{matrix}( proportion of modified polyolefin resin ) + \\ ( proportion of unmodified polyolefin resin )\end{matrix}} \times 100. \qquad ( 8 )$$

The materials used for each example and comparative example are described below. The bending elastic modulus and acid value of each molded product prepared from the polyolefin resin (a) are shown in Tables.

Modified polyolefin resin (a-1)-1: modified high density polyethylene having a MFR of 5.0 g/10 min at 190° C. under a load of 2.16 kg, a density of 954 kg/m³ as measured according to ISO 1183 (2013), and an acid value of 23.0 mgKOH/g, modified with maleic anhydride.

Modified polyolefin resin (a-1)-2: modified high density polyethylene having a MFR of 5.8 g/10 min at 190° C. under a load of 2.16 kg, a density of 954 kg/m³ as measured according to ISO 1183 (2013), and an acid value of 23.0 mgKOH/g, modified with maleic anhydride.

Modified polyolefin resin (a-1)-3: modified high density polyethylene having a MFR of 1.7 g/10 min at 190° C. under a load of 2.16 kg, a density of 960 kg/m³ as measured according to ISO 1183 (2013), and an acid value of 19.0 mgKOH/g, modified with maleic anhydride.

Modified polyolefin resin (a-1)-4: modified high density polyethylene having a MFR of 5.0 g/10 min at 190° C. under a load of 2.16 kg, a density of 954 kg/m³ as measured according to ISO 1183 (2013), and an acid value of 9.0 mgKOH/g, modified with maleic anhydride.

Modified polyolefin resin (a-1)-5: modified high density polyethylene having a MFR of 5.8 g/10 min at 190° C. under a load of 2.16 kg, a density of 952 kg/m³ as measured according to ISO 1183 (2013), and an acid value of 11.4 mgKOH/g, modified with maleic anhydride.

Unmodified polyolefin resin (a-2)-1: high density polyethylene having a MFR of 0.04 g/10 min at 190° C. under a load of 2.16 kg, and a density of 953 kg/m³ as measured according to ISO 1183 (2013).

Unmodified polyolefin resin (a-2)-2: high density polyethylene having a MFR of 5.8 g/10 min at 190° C. under a load of 2.16 kg, and a density of 953 kg/m³ as measured according to ISO 1183 (2013).

Unmodified polyolefin resin (a-2)-3: high density polyethylene having a MFR of 0.03 g/10 min at 190° C. under a load of 2.16 kg, and a density of 953 kg/m³ as measured according to ISO 1183 (2013).

Unmodified polyolefin resin (a-2)-4: low density polyethylene having a MFR of 8.0 g/10 min at 190° C. under a load of 2.16 kg, and a density of 918 kg/m³ as measured according to ISO 1183 (2013).

Polyamide resin (b)-1: polyamide 6 having a melting point of 225° C. as measured by DSC and a relative viscosity of 2.35. To determine the melting point, about 10 mg of the polyamide resin was sampled and the polyamide resin sample was heated in a nitrogen atmosphere from 40° C. to 300° C. at a heating rate of 20° C./min using a DSC (differential scanning calorimeter) manufactured by Perkin Elmer, maintained at 300° C. for 1 minute, cooled from 300° C. to 40° C. at a cooling rate of 20° C./min, maintained at 40° C. 1 minute, and heated again from 40° C. to 300° C. at a heating rate of 20° C./min while determining the endothermic peak temperature. A 98% concentrated sulfuric acid solution with a sample concentration of 0.01 g/ml was prepared and the relative viscosity at 25° C. was measured using an Ostwald viscometer.

Polyamide resin (b)-2: polyamide 610 having a melting point of 220° C. as measured by DSC and a relative viscosity of 2.7. To determine the melting point, about 10 mg of the polyamide resin was sampled and the polyamide resin sample was heated in a nitrogen atmosphere from 40° C. to 300° C. at a heating rate of 20° C./min using a DSC (differential scanning calorimeter) manufactured by Perkin Elmer, maintained at 300° C. for 1 minute, cooled from 300° C. to 40° C. at a cooling rate of 20° C./min, maintained at 40° C. 1 minute, and heated again from 40° C. to 300° C. at a heating rate of 20° C./min while determining the endothermic peak temperature. A 98% concentrated sulfuric acid solution with a sample concentration of 0.01 g/ml was prepared and the relative viscosity at 25° C. was measured using an Ostwald viscometer.

### Examples 1 to 12 and Comparative Examples 1 to 5

The various types of modified polyolefin resin (a-1), unmodified polyolefin resin (a-2), and polyamide resin (b) were mixed according to the proportions shown in Tables 2 and 3. Subsequently, while removing the volatile components by a vacuum pump, the mixture was melt-extruded at a barrel temperature at 230° C. to 250° C. using a twin screw extruder with a screw diameter of 37 mm (TEM37, manufactured by Toshiba Machine Co., Ltd.). The discharge rate was 40 kg/hr and the screw rotating speed was 350 rpm. The discharged resin was pulled to produce a strand and cooled by passing it through a cooling bath, and cut by a pelletizer while pulling it to prepare pellets of our resin compositions. Results of the evaluations described above are shown in Tables 1-3.

TABLE 1

| | | | unit | Example 1 | Example 2 | Example 3 | Example 4 | Example 5 | Example 6 |
|---|---|---|---|---|---|---|---|---|---|
| (a) | (a-1) | modified polyolefin resin 1 | wt % | 18 | 25 | 18 | 18 | 18 | 18 |
| | | modified polyolefin resin 2 | wt % | — | — | — | — | — | — |
| | | modified polyolefin resin 3 | wt % | — | — | — | — | — | — |
| | | modified polyolefin resin 4 | wt % | — | — | — | — | — | — |
| | | modified polyolefin resin 5 | wt % | — | — | — | — | — | — |
| | (a-2) | unmodified polyolefin resin 1 | wt % | 16 | 22.5 | 16 | — | 12 | 24 |
| | | unmodified polyolefin resin 2 | wt % | 16 | 2.5 | 16 | — | 20 | 8 |
| | | unmodified polyolefin resin 3 | wt % | — | — | — | — | — | — |
| | | unmodified polyolefin resin 4 | wt % | — | — | — | 32 | — | — |

| (b) | polyamide resin 1 | wt % | 50 | 50 | — | 50 | 50 | 50 |
|---|---|---|---|---|---|---|---|---|
| | polyamide resin 2 | wt % | — | — | 50 | — | — | — |
| proportion of polyolefin resin | | wt % | 50 | 50 | 50 | 50 | 50 | 50 |
| proportion of polyamide resin | | wt % | 50 | 50 | 50 | 50 | 50 | 50 |
| acid value | acid value of modified | mgKOH/g | 23.0 | 23.0 | 23.0 | 23.0 | 23.0 | 23.0 |
| | polyolefin resin | | | | | | | |
| proportion of modified | proportion | wt % | 36 | 50 | 36 | 36 | 36 | 36 |
| polyolefin resin | | | | | | | | |
| melt viscosity ratio | shear rate 1,216 sec⁻¹ | — | 0.57 | 0.57 | 0.57 | 0.57 | 0.62 | 0.50 |
| bending elastic modulus | polyolefin resin | GPa | 1.0 | 1.0 | 1.0 | 0.4 | 0.9 | 1.0 |
| | polyamide resin | GPa | 2.8 | 2.8 | 2.0 | 2.8 | 2.8 | 2.8 |
| infrared microspectrometry | peak intensity ratio | — | 4.2 | 3.8 | 4.2 | 4.2 | 4.8 | 3.4 |
| analysis | | | | | | | | |
| water absorption capacity | water absorption rate | % | 0.33 | 0.32 | 0.26 | 0.42 | 0.25 | 0.51 |
| fuel barrier property | fuel permeability | g/(m² 24 h) | 12 | 15 | 12 | 18 | 17 | 13 |
| weldability | welding force | N | 380 | 350 | 300 | 300 | 340 | 280 |
| moldability | surface stripping | — | A | A | A | A | A | A |

TABLE 2

| | | | unit | Example 7 | Example 8 | Example 9 | Example 10 | Example 11 | Example 12 |
|---|---|---|---|---|---|---|---|---|---|
| (a) | (a-1) | modified polyolefin resin 1 | wt % | 18 | 18 | — | — | 23.4 | 12.6 |
| | | modified polyolefin resin 2 | wt % | — | — | 25 | — | — | — |
| | | modified polyolefin resin 3 | wt % | — | — | — | 18 | — | — |
| | | modified polyolefin resin 4 | wt % | — | — | — | — | — | — |
| | (a-2) | modified polyolefin resin 5 | wt % | — | — | — | — | — | — |
| | | unmodified polyolefin resin 1 | wt % | 7 | — | 25 | 16 | 20.8 | 11.2 |
| | | unmodified polyolefin resin 2 | wt % | 25 | — | — | 16 | 20.8 | 11.2 |
| | | unmodified polyolefin resin 3 | wt % | — | 32 | — | — | — | — |
| | | unmodified polyolefin resin 4 | wt % | — | — | — | — | — | — |

| (b) | polyamide resin 1 | wt % | 50 | 50 | 50 | 50 | 35 | 65 |
|---|---|---|---|---|---|---|---|---|
| | polyamide resin 2 | wt % | — | — | — | — | — | — |
| proportion of polyolefin resin | | wt % | 50 | 50 | 50 | 50 | 65 | 35 |
| proportion of polyamide resin | | wt % | 50 | 50 | 50 | 50 | 35 | 65 |
| acid value | acid value of modified | mgKOH/g | 23.0 | 23.0 | 23.0 | 19.0 | 23.0 | 23.0 |
| | polyolefin resin | | | | | | | |
| proportion of modified | proportion | wt % | 36 | 36 | 50 | 36 | 36 | 36 |
| polyolefin resin | | | | | | | | |
| melt viscosity ratio | shear rate 1,216 sec⁻¹ | — | 0.68 | 0.30 | 0.78 | 0.57 | 0.57 | 0.57 |
| bending elastic | polyolefin resin | GPa | 0.9 | 0.9 | 1.0 | 1.1 | 1.0 | 1.0 |
| modulus | polyamide resin | GPa | 2.8 | 2.8 | 2.8 | 2.8 | 2.8 | 2.8 |
| infrared | peak intensity ratio | — | 5.0 | 3.0 | 3.8 | 4.5 | 4.8 | 3.2 |
| microspectrometry | | | | | | | | |
| analysis | | | | | | | | |
| water absorption | water absorption rate | % | 0.24 | 0.52 | 0.32 | 0.35 | 0.28 | 0.48 |
| capacity | | | | | | | | |
| fuel barrier property | fuel permeability | g/(m² 24 h) | 20 | 14 | 15 | 12 | 18 | 9 |
| weldability | welding force | N | 330 | 260 | 300 | 370 | 370 | 300 |
| moldability | surface stripping | — | A | A | A | A | A | A |

TABLE 3

| | | | | Comparative | Comparative | Comparative | Comparative | Comparative |
|---|---|---|---|---|---|---|---|---|
| | | | unit | Example 1 | Example 2 | Example 3 | Example 4 | Example 5 |
| (a) | (a-1) | modified polyolefin resin 1 | wt % | — | 9 | 27 | — | — |
| | | modified polyolefin resin 2 | wt % | — | — | — | — | — |
| | | modified polyolefin resin 3 | wt % | — | — | — | — | — |
| | | modified polyolefin resin 4 | wt % | 18 | — | — | 18 | — |
| | | modified polyolefin resin 5 | wt % | — | — | — | — | 25 |
| | (a-2) | unmodified polyolefin resin 1 | wt % | 16 | 8 | 24 | — | 25 |
| | | unmodified polyolefin resin 2 | wt % | 16 | 8 | 24 | — | — |
| | | unmodified polyolefin resin 3 | wt % | — | — | — | 32 | — |
| | | unmodified polyolefin resin 4 | wt % | — | — | — | — | — |

| (b) | polyamide resin 1 | wt % | 50 | 75 | 25 | 50 | 50 |
|---|---|---|---|---|---|---|---|
| | polyamide resin 2 | wt % | — | — | — | — | — |
| proportion of polyolefin resin | | wt % | 50 | 25 | 75 | 50 | 50 |
| proportion of polyamide resin | | wt % | 50 | 75 | 25 | 50 | 50 |
| acid value | acid value of modified | mgKOH/g | 9.0 | 23.0 | 23.0 | 9.0 | 11.4 |
| | polyolefin resin | | | | | | |
| proportion of modified | proportion | wt % | 36 | 36 | 36 | 36 | 50 |
| polyolefin resin | | | | | | | |
| melt viscosity ratio | shear rate 1,216 sec⁻¹ | — | 0.65 | 0.57 | 0.57 | 0.33 | 0.78 |
| bending elastic modulus | polyolefin resin | GPa | 1.0 | 1.0 | 1.0 | 0.9 | 1.0 |
| | polyamide resin | GPa | 2.8 | 2.8 | 2.8 | 2.8 | 2.8 |
| infrared | peak intensity ratio | — | 5.4 | 2.1 | 5.5 | 2.2 | 5.8 |
| microspectrometry | | | | | | | |
| analysis | | | | | | | |
| water absorption capacity | water absorption rate | % | 0.24 | 0.70 | 0.18 | 0.55 | 0.20 |
| fuel barrier property | fuel permeability | g/(m² 24 h) | 20 | 11 | 30 | 20 | 18 |
| weldability | welding force | N | 200 | 120 | 240 | 150 | 150 |
| moldability | surface stripping | — | C | B | B | B | C |

From the results shown in Tables 1-3, it is seen that our resin compositions have both high level fuel permeation resistance and high weldability to welding material (polyolefin resin) and also have high moldability to realize the production of a molded resin product free of surface stripping. It can also be seen that the molded products can show good characteristics to work under a wide variety of service conditions such as for automobiles. On the other hand, comparative resin compositions out of the scope of our compositions do not have both high level fuel permeation resistance and high weldability to welding material (polyolefin resin), only serve to produce molded resin products suffering surface stripping, and undergo a deterioration in characteristics such as moldability.

### INDUSTRIAL APPLICABILITY

Our resin compositions realize both high level fuel permeation resistance and high weldability to polyolefin resin and also serve to produce a molded resin product free of surface stripping or the like and serves suitably as material for automobile parts, medical care tools, tools for daily living.

1-11. (canceled)

12. A resin composition comprising a polyolefin resin (a) and a polyamide resin (b) accounting for 100 wt % in total, the polyolefin resin (a) and the polyamide resin (b) accounting for 70 to 30 wt % and 30 to 70 wt %, respectively, and a surface of a molded resin product produced from the resin composition, analyzed by infrared microspectrometry, giving a spectrum peak intensity ratio of 3.0 to 5.0 as calculated by equation (1), wherein
a melt viscosity ratio defined by equation (2) is 0.35 to 0.64 when measured at a shear rate of 1.216 second' and at a temperature of Tp+20° C., wherein Tp (° C.) represents the melting point of the polyolefin resin (a) or that of the polyamide resin (b), whichever is higher:
$$\begin{matrix}Peak intensity ratio = \frac{absorbance near 2 , 950 {cm}^{- 1}}{absorbance near 3 , 300 {cm}^{- 1}} & ( 1 ) \\ Melt viscosity ratio = \frac{melt viscosity of polyamide resin ( b )}{melt viscosity of polyolefin resin ( a )} . & ( 2 )\end{matrix}$$

13. The resin composition as set forth in claim 12, wherein the polyolefin resin (a) comprises a modified polyolefin resin (a-1) and an unmodified polyolefin resin (a-2).

14. The resin composition as set forth in claim 13, wherein the modified polyolefin resin (a-1) has an acid value of 12 mgKOH/g to 35 mgKOH/g.

15. The resin composition as set forth in claim 12, wherein the polyolefin resin (a) contains a polyolefin resin modified with at least one compound selected from unsaturated carboxylic acids and derivatives thereof.

16. The resin composition as set forth in claim 12, wherein a dumbbell shaped test piece with an overall length of 170 mm, a parallel part length of 80 mm, a parallel part width of 10 mm, and a thickness of 4 mm prepared therefrom in accordance with JIS K7139 (2009) Type A1 and subjected to measurement of a weight difference between before and after 24-hour immersion in water at 23° C. has a water absorption rate of 0.26% to 0.50% as calculated by equation (3):
$$Water absorption rate ( \% ) = \text{} \frac{\begin{matrix}( weight in water absorbed state ) - \\ ( weight in absolute dry state )\end{matrix}}{( weight in absolute dry state )} \times 100. \qquad ( 3 )$$

17. The resin composition as set forth in claim 12, wherein the polyolefin resin (a) produces a molded product having a bending elastic modulus of 0.5 to 1.3 GPa.

18. The resin composition as set forth in claim 12, wherein the polyamide resin (b) produces a molded product having a bending elastic modulus of 2.5 to 3.0 GPa.

19. The resin composition as set forth in claim 13, wherein the modified polyolefin resin (a-1) and the unmodified polyolefin resin (a-2) account for 1 to 46 wt % and 99 to 54 wt %, respectively, relative to the total weight of the modified polyolefin resin (a-1) and the unmodified polyolefin resin (a-2), which accounts for 100 wt %.

20. A molded resin product produced from the resin composition as set forth in claim 12.

21. A container for conveyance or storage of gas and/or liquid or an accessory part thereof comprising the molded resin product as set forth in claim 20.
